(19) United States
(12) Patent Application Publication
(10) Pub. No.: US 2009/0138515 A1
(43) Pub. Date: May 28, 2009

(54) APPARATUS AND METHOD FOR COMMUNICATING, ACCESSING, ORGANIZING, AND/OR MANAGING, INFORMATION IN A NETWORK ENVIRONMENT

(76) Inventors: Archit A. Amin, Bernardsville, NJ (US); Deepak A. Amin, Bernardsville, NJ (US)

Correspondence Address: KLAUBER & JACKSON, 411 HACKENSACK AVENUE, HACKENSACK, NJ, 07601, US

(21) Appl. No.: 12/269,314

(22) Filed: Nov. 12, 2008

Related U.S. Application Data
(60) Provisional application No. 60/987,396, filed on Nov. 12, 2007.
(60) Provisional application No. 61/108,542, filed on Oct. 26, 2008.

(51) Int. Cl. G06F 7/00

(52) U.S. Cl. 707/104.1; 707/E17.009

(57) ABSTRACT

A computer-implemented method, including transmitting a message to a user computer, receiving a reply to the message which contains information for creating a task, a project, a project task, or a message stream, in response to the message, determining, using a processing device or a computer, whether the reply contains a request to create a task, a project, or a project task, in response to the message, creating a communication record for the message and the reply if the reply does not contain a request to create a task, a project, or a project task, in response to the message, or creating a communication record for a task, a project, or a project task, if the reply contains a request to create a task, a project, or a project task, and storing the communication record in a database or a memory device.

### RELATED APPLICATIONS

This application claims the benefit of priority of U.S. Provisional Patent Application Ser. No. 60/987,396, filed Nov. 12, 2007, and entitled “TASK-CENTRIC COMMUNICATIONS SYSTEM”, the subject matter and teachings of which is hereby incorporated by reference herein. This application also claims the benefit of priority of U.S. Provisional Patent Application Ser. No. 61/108,542, filed Oct. 26, 2008, and entitled “TASK-CENTRIC COMMUNICATIONS SYSTEMS”, the subject matter and teachings of which is hereby incorporated by reference herein.

### FIELD OF THE INVENTION

The present invention pertains to an apparatus and method for communicating, accessing, organizing, and/or managing, information in a network environment and, in particular, to an apparatus and method for communicating, accessing, organizing, and/or managing, information in a network environment which provides for the efficient and effective organization and management of communications and/or messages transmitted between individuals which facilitates enhanced organization, access, and accountability, regarding same.

### BACKGROUND OF THE INVENTION

Individuals and organizations rely on the ability to effectively communicate ideas and/or messages to others in virtually all aspects of everyday life. Forms of communications involving telephone calls, electronic mail (e-mail) messages, instant messaging messages, facsimile (fax) transmissions or messages, and/or other modes of communications, are typically used by individuals and businesses to communicate ideas and/or messages.

One major problem with the above listed, as well as other types of, communication modes lies in the fact that each communication or message is typically a separate and/or an isolated event. Therefore, with the exception of a one-time or a single communication or message, any previous or subsequent communications, messages, or dialog, which depend upon, or which require multiple communications or messages, requires that the sending and/or receiving individuals or entities must organize and/or manage his, her, or its, its own communications or messages in order to accomplish some task or goal which may be the subject of the communications, messages, or dialog.

For example, a dialog between two or more individuals who are attempting to communicate ideas or who are attempting to accomplish a task or goal, based wholly or partly on e-mail messages sent between these individuals, typically requires that each individual be responsible for knowing when messages are sent, the content of the message, and, in some instances, when a response is needed or appropriate.

One need only access his or her e-mail “in-box” to know that he or she can often find a multitude of e-mail messages which have to be sifted through in order to locate a message which may pertain to a particular task or project in which the individual can be involved or interested. In the case of telephone calls, instant messages, and/or fax messages, which messages also are typically isolated occurrences, these messages typically require that the individual be able to mentally connect these messages with other previous or subsequent messages which may pertain to a given task or project.

The present invention overcomes the shortfalls of existing communication platforms and systems by providing an apparatus and method for communicating, accessing, organizing, and/or managing, information in a network environment as described herein.

### SUMMARY OF THE INVENTION

The present invention pertains to an apparatus and method for communicating, accessing, organizing, and/or managing, information in a network environment which overcomes the shortfalls of the prior art.

The present invention can be utilized in order to create, organize, and/or manage, messages which are sent between individuals or organizations by defined tasks or assigned tasks, by projects related to those defined tasks or assigned tasks, by project tasks related to those projects, and/or any other messages or communications. The present invention can be utilized by individuals or by an organization in order to organize and/or manage messages sent by and/or between individuals or organizations so that these messages, and any information contained therein, can be communicated, accessed, organized, and/or managed, by any individual or individuals in an efficient and effective manner.

The present invention provides an effective and efficient means by which a stream of messages can be formed, updated, and/or maintained, which may result from, or which may relate to, a single message between individuals, a defined task or assigned task which can be created to address, or in response to, a message, a stream of messages sent by and/or between individuals which relate to, or result from, the defined task or assigned task, a project or projects which may result from a defined task or an assigned task, and/or a project task or project tasks which may relate to, or which may result from, the project task or project tasks. The present invention can also be utilized to manage any stream or streams of messages which may not be related to any assigned task or defined task, any project, or any project tasks.

By providing an organized system and method by which messages can be organized, updated, and/or managed, the present invention provides an effective and efficient communications system and platform which facilitates enhanced communications between individuals, enhanced communication organization and efficiency, and enhanced accountability among individuals.

The present invention can be utilized by and between any number of users or individuals to communicate and/or to recognize an initial message which can result in a need for a defined task or an assigned task to address a subject of the message. In response to the need for a defined task or an assigned task, a task stream can be created which can be utilized to organize and manage any and/or all subsequent messages which address that task. The initial message can be the basis for creating the defined task or the assigned task. The defined task or assigned task can then be the basis for creating a project which needs to be accomplished in order to perform the defined task or the assigned task, and similarly, the project can, in turn, be the basis for creating one or more project tasks.

Messages which pertain to the defined task or the assigned task, the project or projects related to the defined task or the assigned task, the project task or project tasks, the project talk, and/or the messages, can then be organized into a respective message stream or “stream” which can then be communicated, accessed, organized, and/or managed, by any respective user, individual, or organization, involved in the defined task or assigned task, the project or projects, or the project task or project tasks.

The ability to communicate, access, organize, and/or manage, these respective streams provides for enhanced communication efficiency and facilitates enhanced accountability in managing and performing the respective defined task or the assigned task, the project or projects relating to the defined task or the assigned task, and the project task or project tasks relating to a project.

The present invention can also be utilized in order to allow users and individuals to track messages, defined tasks or assigned tasks, projects, and/or project tasks, more efficiently and effectively.

The present invention can also be utilized in connection with, and/or can be adapted to be utilized in connection with, communicating, accessing, organizing, and/or managing, with electronic mail (e-mail message) messages, instant messaging messages (“instant messages”) and/or any other type or form of electronic messages or communications techniques.

The present invention can be utilized as a communication platform by and between individuals, family members, friends and social communities, as well by businesses and organizations of any size or type.

The apparatus of the present invention can include one or more communications servers or computers, or a set, or any number of sets of, servers or computers. A server can include one or more computers or computer systems and can be equipped to serve as an e-mail server or any other appropriate communications server. The server can also be programmed to perform any and/or all of the functions and functionality described herein as being performed and/or as being provided by the present invention. A server or computer, or a set of servers or computers, utilized in connection with the present invention, can store any of the data, information, or messages, described herein in any centralized and/or de-centralized manner.

The apparatus can also include any number of user computers or devices, which can be any computer or communication device which can be utilized by a user or an individual to utilize the present invention as described herein. The user computer or device can be a personal computer, a laptop computer, a hand-held computer, a wireless telephone, a cellular telephone, or a personal digital assistant, and/or can be any other wired or wireless computer or communication device.

The present invention can be utilized in connection with any suitable communications network, system, or platform. For example, the present invention can be utilized on or over the Internet and/or the World Wide Web, an Intranet or Intranets, or a combination of the Internet and/or the World Wide Web and an Intranet or Intranets. The communications network or platform can also be, or can include, any local area network or any wide are network, a public switched telephone network, and/or any other suitable communications network and/or wireless communications network.

The present invention can be designed to create and utilize certain defined relationships between and among the various messages, defined tasks or assigned tasks, projects, and project tasks, described herein. Any and/or all communications can begin with a message being sent from one user or individual to one or more other users or individuals. The message can contain text of the message or message subject matter which can be referred to herein as a message detail (also referred to as a “message detail unit” or “MDU”).

The message or MDU derived from the message can be typically the first or initial communication in what may become a stream of messages or MDUs. The sender, the receiver, or any other user or individual who receives the message, can decide whether a defined task or an assigned task should be created as the result of the message or in order to deal with the subject matter of the message. If a defined task or an assigned task is desired to be created then such a defined task or an assigned task is created, and any and/or all information regarding the first or initial message, and the creation of the defined task or the assigned task, will be stored in an appropriate manner. Any new e-mail message can be added to an existing stream as a message data unit or MDU.

A manager or a head can then be assigned to manage or head up the defined task or the assigned task. In the present invention, every defined task or assigned task which is created can be assigned a task manager or a task head. Any user or individual who sends, receives, or views, the first or initial message can determine whether the defined task or the assigned task is to be created.

The present invention can utilize any appropriate hierarchy in order to define relationships between defined tasks or assigned tasks, projects, project tasks, messages, and/or project talk. For example, a first or initial message or MDU can be the most basic information and can be the starting point for any stream created by the present invention. A stream can be created for a task, a project, a project task, a message, and/or project talk. A task, a project, or a project task, can also be created directly from, or as the result of, a message or an MDU.

If a defined task or an assigned task is created, any user or individual who sends, receives, or views, the first or initial message, or who sends, receives, or views, any message creating the defined task or the assigned task, can decide whether a project or projects should be created to accomplish the defined task or the assigned task.

If a project is to be created, then a manager or head will be assigned to manage or oversee the project. In the present invention, it is desirable, thought not required, that every project which is created can or should have a project manager or a project head. Any or all information regarding the creation of the project can be stored in any appropriate device or location upon the creation of the project.

Any user or individual, or the project manager or project head, who sends, receives, or views, a message creating the project can decide whether, and which, project tasks are to be created to accomplish the project. If a project is to be created, then a manager or head will then be assigned to manage or oversee the project. If a project task is determined to be created, then such a project task can be created, and any and/or all information regarding the creation of the project task can also be stored in an appropriate device or location. Typically, if a project task is created, then a project task manager or a project task head can be assigned to manage or oversee the project task.

Any and/or all information regarding any messages or replies thereto, which result in the creation of the above referenced messages, defined tasks or assigned tasks, projects, project tasks, and/or project talk, can be stored in any appropriate device or location.

At any time during any communications regarding any defined task or assigned task, any project, any project task, any message, and/or any project talk, a new defined task or assigned task, a new project, and/or a new project task, can, in turn, be created in response to any message or MDU sent by any of the users or individuals involved in any communications or messages regarding the created defined task or assigned task, any project, or any project task, any message, and/or any project talk.

In an enterprise organization, for example, user or individual relationships to other users or individuals can be defined by either a manager-aid relationship, where one party is a manager of the aid, and/or a peer relationship, where parties are only peers to one another. One of the attributes which can be defined when a user or individual is initially introduced into the system is the user relations criteria which can be used to define the relationship between the user or individual and other users or individual whom that user or individual will be working with on a day-to-day basis. Relationships between users or individuals can be defined, re-defined, changed, created, or dissolved, at any time.

In the present invention, all users or individuals need not be on-line at the same time in order to view a message(s) or a message record(s) being viewed by other users or individuals. Rather, a user or individual can access the server at any time and retrieve a message(s) or a message record(s) at any time and from any location via any suitable user computer or device.

The user or individual can view a message or message record for any message, defined task or assigned task, project, and/or project task, described herein in a screen session or sessions via the user computer or device. The user or individual can also view any number of messages or message records for any number of the messages, defined tasks or assigned tasks, projects, project tasks, messages, and/or project talk, described herein, in multiple sessions with the user computer or device.

A stream, which can be a stream for a task, a project, a project task, a message, and/or project talk, can consist of a header and a string or chain of connected message detail units (MDUs) which are associated with that header, in the order of most recent message detail unit (MDU) to earliest message detail unit (MDU).

The present invention can be utilized to create a defined task or an assigned task from a message or an MDU. A defined task or an assigned task can originate from a message or an MDU sent from one user or individual to one or more other users or individuals. A user or individual (“the sending user or individual”) can generate and send an e-mail message to one or more other users or individuals (“the receiving user(s) or individual(s)”). The e-mail message can contain any subject matter. The e-mail message may simply contain a greeting or a message between friends, or it can contain subject matter which may require or need attention, such as, for example, a recognized need to perform a task, such as a work-related task, such as in a business setting.

Any one or more of the sending user or individual or the receiving user(s) or individual(s) can determine whether or not to create a defined task or an assigned task to address the task or, in other words, to convert the subject matter of the message or MDU to a defined task or an assigned task (hereinafter, “the task”). The creation of the task can be performed in any appropriate manner.

Information regarding the e-mail message or MDU, the subject matter of the e-mail message or MDU, the sender of the e-mail message or MDU, the receiver or receivers of the e-mail message or MDU, the text of the e-mail message or MDU, and information regarding whether a task is to be created, can be stored in the respective server through which the e-mail message or MDU is provided.

The server can determine whether or not a task has been created or, to put it in other words, whether the subject matter of the e-mail message or MDU has been converted to a task. The server can also determine that no task was created from the e-mail message or MDU, and the present invention will create a communication record for the e-mail message or MDU and any response or responses thereto. The communication record containing the e-mail message or MDU and any response or responses thereto will then be stored in the server, in a database of or associated with same, and/or in an external database.

If a task is created from the e-mail message or MDU, or that the subject matter of the e-mail message or MDU has been “converted to a task”, the present invention can create a communications record for the task and can create and store any information regarding any task assignment associated with the task. The communication record containing the task or task assignment can then be stored. A task manager or head for the task can be assigned to the task and other information regarding same can also be stored. Information regarding any and/or all users or individuals who are to be involved in performing the task, and the relationship(s) between them, can also be stored in the communications record for the task. Information regarding a goal of the task, a start date, a completion date, and/or a deadline, associated with the task, can also be stored in the communication record for the task.

The present invention can determine, from information obtained from an e-mail message or MDU, from any response(s) thereto, from any other information provided by any appropriate user(s) or individual(s), and/or from any previously defined rule or rules concerning task execution, whether or not any additional assignments are required to execute the task. If it is determined that an additional assignment, or multiple assignments, needs to be performed, then the apparatus can create and store a project record which is created to address the additional assignment or each assignment of the multiple assignments.

Information regarding a project head and any information regarding any and/or all users or individuals who are to be involved in performing the project, and the relationship(s) between them, can also be stored in the communications record for the project. Thereafter, the user(s) or individual(s) assigned to the task will perform his/her/their respective assignment to execute and complete the task. Any e-mail messages or MDUs which are transmitted by, or received by, the user(s) or individual(s) assigned to the task can also be organized together in streams which can also be stored.

The present invention can also be utilized in order to create or establish a messaging platform for a task, which can include the creation of, and the development and/or propagation of, a stream for the task. In such an application, upon a creation of a task, a communication record for the task can be created with information regarding same, including, but not limited to, information regarding the task manager or head, information regarding any and/or all users or individuals who are to be involved in performing the task, and the relationship(s) between them, and/or information regarding a goal of the task, a start date, a completion date, and/or a deadline, associated with the task.

This information can also be stored in the communication record for the task. Any message, messages, or MDUs, associated with the task, such as the message or MDU from which the task was created or the subject matter of same which was “converted to a task”, and any response or responses to same, can also be stored in the communication record for the task. Thereafter, the apparatus of the present invention can also create or initiate the stream for the task or task stream.

As e-mail messages or MDUs are generated and transmitted to, from, or between, any of the users or individuals assigned to the task, the present invention can, for each e-mail message, generate a message detail unit (MDU) corresponding to the e-mail message, and the MDU can be linked to, or inserted into, the stream for the task. An MDU or multiple MDUs can be added to the stream for the task until the task is completed or until the cessation of any e-mail messages or MDUs associated with the task. Each time the stream for a task is updated to include a new MDU, the updated stream can be stored.

Any and/or all streams created by the present invention, including streams for any and/or all defined tasks or assigned tasks, projects, project tasks, project talk, and/or messages, described herein, can be created, updated, and stored, in any appropriate manner.

The present invention can also be utilized to update any stream for any of the tasks, projects, project tasks, project talk, and/or messages, described herein.

The apparatus of the present invention, upon receiving an e-mail message sent from a sending user or individual, and before transmitting the e-mail message to a receiving user(s) or individual(s), can process information regarding the e-mail message and generate an MDU associated with the e-mail message. Thereafter, the stream for the respective defined task or assigned task, project, project task, project talk, and/or message, can be identified and the newly generated MDU can be added thereto.

The resulting updated stream can thereafter be stored and can be available for accessing and viewing by any authorized user or individual.

The present invention can also record any information regarding any message or MDU acknowledgement(s) or non-acknowledgements by any one or more users or individuals indicating that they respectively have either acknowledged or failed to acknowledge receiving an MDU in a stream.

The present invention can also be utilized in order to process e-mail messages, to generate an MDU therefrom, and to update an appropriate stream, for any streams for any of the herein-described defined tasks or assigned tasks, projects, project tasks, project talk, and/or messages.

The present invention can also be utilized in order to provide an efficient and effective means by which to communicate, access, organize, and/or manage, information in a network environment. Any user or individual involved in an enterprise, organization, group, and/or any other relation or association with others, can utilize the present invention to communicate with others, access pertinent information in an organized and efficient manner, organize his or her communications, and/or manage his or her communications and/or interaction with other users or individuals.

Messages, including e-mail messages, and streams which can be task-based, project-based, project task-based, project talk-based, or which can be miscellaneous messages between users or individuals, can be easily accessed, viewed, responded to, and/or otherwise addressed, in a simple an easy manner. The ease and simplicity provided by the present invention can be utilized to provide for improved and more organized communication efficiencies and effectiveness, while promoting more organized information dissemination and accountability among users and individuals.

The present invention can also be utilized to allow users or individuals to access and act upon messages and information contained therein. A user or individual can access the information provided by the present invention via any suitable user computer or device. Once obtaining access to the apparatus of the present invention, the user or individual can request a particular stream (“stream request”) for any defined task or assigned task, a project, a project task, a message, and/or project talk, which he or she is interested in accessing.

The present invention can process the user's or individual's stream request and transmit the requested stream to the user computer or device. Thereafter, the user or individual can view the stream and decide whether or not he or she desires to add a message in the form of an MDU to the stream. If the user or individual desires to add to or to update the stream, such as when responding to a message or MDU or communicating a new message, the user or individual will generate and transmit a new e-mail message to a recipient or recipients and, thereafter, transmit the new e-mail message to the apparatus of the present invention for processing. The user or individual can, instead of, or in addition to adding a new MDU to the stream, can decide to create a new task from the stream, add a reminder request regarding the task which is the subject to the stream, and/or provide information regarding whether or not the task which is the subject to the stream can be completed.

The present invention can either receive a new e-mail message or determine that the user or individual has exited the stream without adding a new e-mail message. If a new e-mail message is received, then that can be determined to mean that the user or individual desired to add an MDU to the stream. If a new MDU is to be added to the stream, an appropriate MDU can be generated from and in response to the new e-mail message. The MDU can then be added to the stream so as to update same, and the updated stream can be stored.

The present invention can also provide the user or individual with a screen showing tasks, projects, project tasks, project talk, and/or messages, which need to be viewed and/or responded to by the user or individual.

If it is determined that the user or individual desires to create a new task from the stream, a new task can be so created. If it is determined that a reminder has been requested, a reminder will be provided in accordance with the user's or individual's instructions. If it is determined that a task is expected to be completed, then information regarding same can be stored. Thereafter, the task can be completed or efforts regarding same can conclude unless the subject of the task is revisited.

In the present invention, any e-mail message which can originate from outside an enterprise, company, group, or association, can be sent to, and stored in the e-mail “in-box” of a user or individual. The user or individual can, at any time, access and/or view the externally originated e-mail message(s). The user or individual can also, at any time, incorporate an externally originated e-mail message into an existing stream as an MDU. The user or individual can also create a new defined task or assigned task, a new project, a new project task, or a new message stream, in response to the externally originated e-mail message. The user or individual can also send a copy of any type of e-mail message(s) described herein into two or more streams.

The present invention can also be utilized in order to take notes or minutes during a meeting between users or individuals and can create an assigned task or defined task directly from the notes or minutes. In this manner, the present invention can be used to create defined tasks or assigned tasks from meeting notes or minutes. These tasks can be stand alone tasks or project tasks of a new or existing project.

The present invention can also be utilized in order to provide a user or individual with the ability to access recently visited streams of any type or kind.

A user or individual can also access any and/or all of the streams of, or associated with, any and/or all of the defined tasks or assigned tasks, projects, project tasks, project talk, and/or messages, for which he or she is responsible or involved. The user or individual can also access any and/or all of the streams of or associated with any and/or all of the defined tasks or assigned tasks, projects, project tasks, project talk, and/or messages, for which any aid of the user or individual is responsible or involved.

The present invention can also be utilized in order to allow a user or individual to, at any time, access any and/or all of the streams of or associated with any and/or all of the defined tasks or assigned tasks, projects, project tasks, project talk, and/or messages, in existence in his or her enterprise, company, group, or association.

Any user or individual described herein can be assigned any number of e-mail addresses with which to utilize the present invention.

Any user or individual, can also request, and/or be provided with, periodic reminder messages for any of the defined tasks or assigned tasks, projects, project tasks, project talk, and/or messages, described herein. A user or individual can create a reminder message for himself or herself as well as for any other user(s) or individual(s). A reminder message can also be set up to generate an MDU or MDUs which can be inserted into, or otherwise added to, any of the herein-described streams.

The present invention can also be utilized in conjunction with security features which dispense with the need for a network administrator. With regard to messages, tasks, projects, project tasks, and/or project talk, users or individuals may need to have access to other common sharable information. The present invention can be utilized in conjunction with security features which can include utilizing authorized access levels and/or privileges to allow a user or individual to have access to, to read, to read only, to read and/or modify, and/or to otherwise act in any appropriate manner, regarding any shared information of any kind or type which is utilized in connection with the present invention, along with the ability for a user or individual, who has a certain authorized access level, or certain privileges, to be able to control the access levels and/or privileges of others in the enterprise, company, group, or association.

A user or individual having a certain authorization level and/or privileges can also pass along and/or define an authorization level, or a lower level of authorization, or can pass along and/or define his or her privilege rights, or lesser privilege rights, to another user or individual.

Authorization levels and privileges can also include the ability of a user or individual to, in turn, pass along these authorization levels, or a lower authorization level(s), and/or privilege rights, or lesser privilege rights, to another user or individual, with authorization levels and privileges being defined or assigned throughout a communication infrastructure or platform in the enterprise, company, group, or association. In this manner, the need for a centralized network administrator can be dispensed with.

### BRIEF DESCRIPTION OF THE DRAWINGS

In the Drawings:

FIG. 1 illustrates a preferred embodiment of the apparatus of the present invention in block diagram form;

FIG. 2 illustrates a preferred embodiment relationship between the various messages, defined tasks or assigned tasks, projects, and project tasks, described herein as being utilized in connection with the apparatus of FIG. 1;

FIG. 3 illustrates a block diagram illustrating a preferred embodiment hierarchy of the relationship between a project manager or project head and a project task head;

FIG. 4 illustrates a simple one-way relationship which may be defined from one user or individual to another in utilizing the apparatus of FIG. 1;

FIG. 5 illustrates a more complicated relationship between users or individuals who utilize the apparatus of FIG. 1;

FIG. 6 illustrates an example of a view of a display screen of the user computer used in connection with the apparatus of the present invention showing numerous sessions open and available to the user or individual via the user computer;

FIG. 7 illustrates a diagram of an example stream which is utilized in connection with the apparatus and method of the present invention;

FIG. 8 illustrates an example of diagram of a project task stream platform that can be used in completing a project, showing a project header, project task streams, and a project talk stream;

FIG. 9 illustrates a preferred embodiment example of a defined task or an assigned task header or a project header utilized in the respective streams of FIGS. 7 and 8;

FIG. 10 illustrates a preferred embodiment example of a message detail unit (MDU);

FIGS. 11A and 11B illustrate a preferred embodiment method for using the apparatus of FIG. 1 to create a defined task or an assigned task from a message;

FIG. 12 illustrates a preferred embodiment method of utilizing the apparatus of FIG. 1 in order to create or establish a tasking platform which can be utilized in connection with the present invention;

FIG. 13 illustrates a preferred embodiment method for utilizing the apparatus of FIG. 1 to update the stream;

FIG. 14 illustrates a preferred embodiment method for utilizing the apparatus of FIG. 1 to access and act upon a message or messages and information contained therein; and

FIG. 15 illustrates an example of a screen shot used for providing information to a user or individual which can be provided via the user computer.

### DESCRIPTION OF THE PREFERRED EMBODIMENTS

The present invention pertains to an apparatus and method for communicating, accessing, organizing, and/or managing, information in a network environment. In particular, the apparatus and method of the present invention can be utilized in order to create, organize, and/or manage, messages sent between individuals or organizations by defined tasks or assigned tasks, projects related to those defined tasks or assigned tasks, project tasks related to those projects, project talk, and/or messages. The apparatus and method of the present invention can be utilized by users or individuals or by an organization in order to organize and/or manage messages sent by and between users, individuals, or organizations, so that these messages, and any information contained therein, can be communicated, accessed, organized, and/or managed, by any user(s) individual(s).

The apparatus and method of the present invention provides an effective and efficient means by which a stream of messages can be formed which may result from, or which may relate to, a single message between individuals, a defined task or assigned task which can be created to address, or be in response to, a message, a stream of messages sent by and between individuals which relate to, or which result from, the defined task or assigned task, a project or projects which may be created by, or which may result from, a defined task or an assigned task, and/or a project task or project tasks which relate to, or which result from, a project. Project talk and other messages can also be organized into streams.

By providing an organized means by which messages can be organized and/or managed, the apparatus and method of the present invention provides an effective and efficient communications system and platform which facilitates enhanced communications between users and individuals, enhanced organization communication and efficiency, and enhanced accountability among users and individuals who utilize the apparatus and method of the present invention.

As and for an illustrative example, the apparatus and method of the present invention can be utilized by and between any number of users or individuals in an enterprise, a company, an organization, a group, or an association, in order to communicate an initial message which can recognize and/or result in a creation of a defined task or an assigned task which needs to be performed in order to address a subject of the initial message or a subsequent message.

In response to the need for a defined task or an assigned task, a task stream can be created which can be utilized to organize and/or manage any and/or all subsequent messages which address that defined task or assigned task. The initial message, or any subsequent message, can be the basis for creating the defined task or the assigned task. The defined task or assigned task can then be the basis for creating a project which needs to be performed or accomplished in order to perform the defined task or the assigned task. Similarly, the project can, in turn, be the basis for creating one or more project tasks.

Messages which pertain to the defined task or the assigned task, to the project or projects related to the defined task or the assigned task, to the project task or project tasks, and/or to project talk, can then be organized into, or linked together, into a respective stream of messages which can be communicated, accessed, organized, and/or managed, by any respective user, individual, or organization, involved in the defined task or assigned task, the project or projects, the project task or project tasks, or the project talk.

The ability to communicate, access, organize, and/or manage these respective streams provides for enhanced communication efficiency and facilitates enhanced accountability in managing and performing the respective defined task or the assigned task, the project or projects relating to the defined task or the assigned task, and the project task or project tasks relating to a project.

The apparatus and method of the present invention can also be utilized in order to allow users or individuals to track messages, defined tasks or assigned tasks, projects, project tasks, and/or project talk, more efficiently and effectively.

It is important to note that, while, for illustration purposes, a specific hierarchy is described herein which relates a defined task or assigned task, a project, a project task, and/or project task, to one another, any appropriate form or hierarchy can be used. Also, any project task can, in turn, be the basis for creating a new or an additional defined task or assigned task, which, in turn, can result in a new project and new project tasks which result from the new or additional defined task or assigned task. Further, any task, project, project talk, or message, can be the basis for creating a new defined task or assigned task, a new project, and/or a new project task.

Further, the terms or phrases “defined task or assigned task”, “project”, “projects”, “project task”, and “project tasks” are selected and used herein merely for convenience and these terms or phrases can be replaced by any other suitable terms or phrases in describing the present invention, and/or any hierarchy of streams which are created, organized, and/or managed, by the apparatus and method of the present invention.

In a preferred embodiment, the apparatus and method of the present invention is described in connection with communicating, accessing, organizing, and/or managing, e-mail communications, and the information contained therein, in a network environment. It is important to note, however, that the apparatus and method of the present invention can also be utilized in connection with, and/or can be adapted to be utilized in connection with, communicating, accessing, organizing, and/or managing, instant messaging messages (“instant messages”) and/or any other forms of electronic messages or electronic transmissions.

The apparatus and method of the present invention can also be utilized as a communication platform by and between individuals, family members, friends, and social communities, as well businesses and organizations of any type, kind, or size. The apparatus and method of the present invention can also be utilized in connection with an enterprise, company, organization, group, or association, located with a single physical facility or in connection with an enterprise, company, organization, group, or association, having any number of remotely located facilities.

For purposes of the description which follows, the following terms or phrases are defined as follows:

“Message” means any information communicated, in text form from one individual or user to one or more individuals or users.

“Message Detail or Message Detail Unit (MDU)” means any single message text sent in a single message.

“Stream” means a string or chain of message details between individuals or users which relate to a same subject or header information.

“Defined Task or Assigned Task” means an assignment communicated by, or resulting from, a message or messages, a message detail or message detail unit (MDU), or a stream, having a goal or objective, a start date, a due date or completion date, and/or an assigned leader.

“Project” means an undertaking that has a goal or an objective and which requires or results in the creation of one or more related project tasks for accomplishing the goal or objective.

“Project Tasks” means an undertaking having a goal or objective which relates to a project.

“Project Talk” means a single message or stream which relates to a specific project, but which is not itself a defined task or an assigned task.

“Committee” means a generalized grouping or community of individuals or organizations which may be responsible for, or have an interest in, a defined task or an assigned task, a project or projects, a project task or project tasks, project talk, or a message or messages.

“Direct Associates” means those colleagues or individuals with whom an individual or user of the present invention may work with on a day-to-day or other basis within a committee or community. The user or individual may have a different set of Direct Associates in each committee or community.

“Head or Manager” means a user or individual assigned to accomplishing, or overseeing, the accomplishing of, a defined task or an assigned task, or a project.

“Message Author” means the user or individual who initiates a message, a stream, or a defined task or an assigned task.

“Enterprise” means an institution or an organization having one or more operating location.

Applicant incorporates by reference herein, in its entirety, the subject matter and teachings of U.S. Provisional Patent Application Ser. No. 60/987,396, filed Nov. 12, 2007, and entitled “TASK-CENTRIC COMMUNICATIONS SYSTEM”, a copy of which is appended hereto as APPENDIX A. Applicant also incorporates by reference herein, in its entirety, the subject matter and teachings of U.S. Provisional Patent Application Ser. No. 61/108,542, filed Oct. 26, 2008, and entitled “TASK-CENTRIC COMMUNICATIONS SYSTEMS”, a copy of which is appended hereto as APPENDIX B.

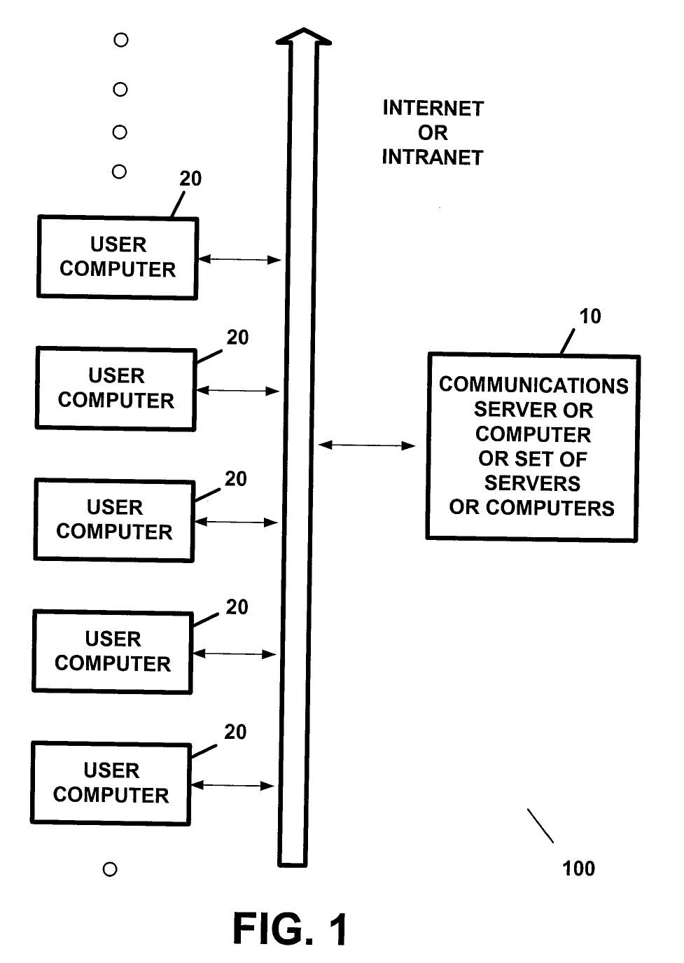

FIG. 1 illustrates a preferred embodiment of the apparatus of the present invention, which is designated generally by the reference numeral 100, in block diagram form. With reference to FIG. 1, the apparatus 100 includes one or more communications servers or computers 10 or a set, or any number of sets of, servers or computers 10 (hereinafter “server” or “server 10”). In the preferred embodiment, the server 10 can include one or more computers or computer systems and can be equipped to serve as an e-mail server or as any other suitable communications computer or network computer which can perform the functionality of the present invention as described herein.

In the preferred embodiment, the server 10 can be programmed to perform all of the functions and functionality described herein as being performed and/or as being provided by the apparatus 100 and method of the present invention. In addition, any server 10 or set of servers or computers utilized in connection with the apparatus 100 can store any of the data, information, streams, or messages, described herein. Further, any server 10 or set of servers or computers utilized in connection with the apparatus 100 can store any of the data, information, streams, or messages, described herein in any centralized and/or de-centralized manner.

Any number of servers 10 can be utilized in the apparatus 100 of the present invention.

With reference once again to FIG. 1, the apparatus 100 also includes any number of user computers or devices 20 (hereinafter “user computer” or “user computer 20”). In a preferred embodiment, each user computer 20 can be, or can include, any computer or communication device which can be utilized by a user or an individual in using the apparatus 100 and method of the present invention as described herein. In a preferred embodiment, the user computer 20 can be a personal computer, a laptop computer, a hand-held computer, a wireless telephone, a cellular telephone, or a personal digital assistant, and/or can be any other wired or wireless computer or communication device. Any number of user computers 20 can be utilized in the apparatus 100 of the present invention, and any user or individual can use any number of user computers 20.

With reference once again to FIG. 1, the apparatus 100 can be utilized in connection with any suitable communications network or platform. For example, in a preferred embodiment, the apparatus 100 and method of the present invention can be utilized on or over the Internet and/or the World Wide Web, on or over an Intranet or Intranets, and/or on or over any other suitable communications network, and/or on or over any combination of the Internet and/or the World Wide Web and an Intranet or Intranets or other communications network or platform. The communications network or platform can also be, or can include, any local area network or any wide are network, a public switched telephone network, and/or any other suitable communications network and/or any wireless communications network.

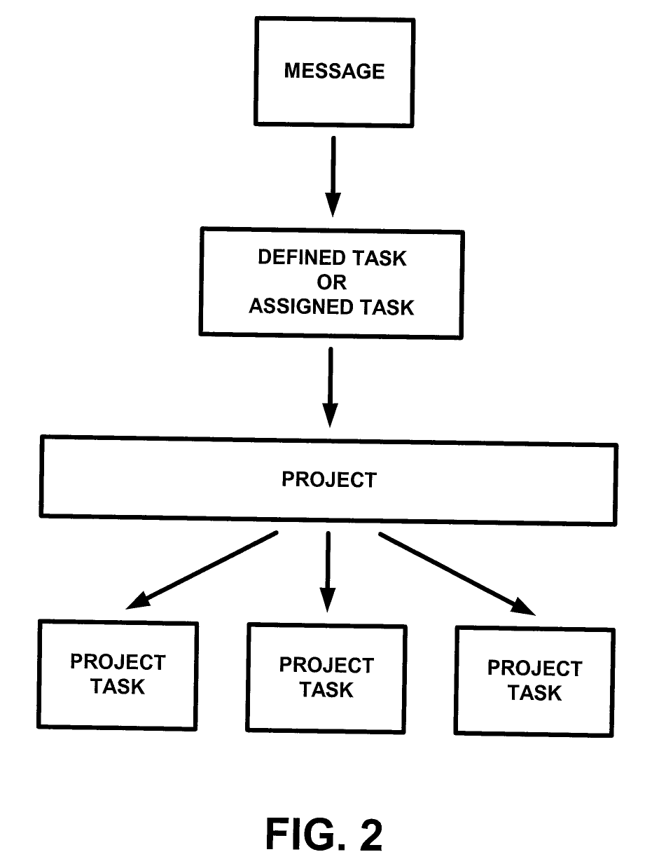

FIG. 2 illustrates a preferred embodiment relationship between the various messages, defined tasks or assigned tasks, projects, and project tasks, described herein as being utilized in connection with the apparatus 100 of the present invention. With reference to FIG. 2, any and/or all communications begins with a message sent from one user or individual to one or more other users or individuals. The message contains a message detail or a message detail unit (MDU) which includes the subject matter or text of the message.

As noted above, the message is the first or initial communication in what may become a stream of messages. In the preferred embodiment, the sender, the receiver, or any user or individual who receives the message can decide whether a defined task or an assigned task should be created from, or as the result of, the message. Once a defined task or an assigned task is determined to be created, then such a defined task or an assigned task is created as shown in FIG. 2, and any and/or all information regarding the first or initial message, information regarding the creation of the defined task or the assigned task, and/or information regarding the defined task or assigned task, will be stored in the server 10, in a database associated with the server 10, and/or in an external database.

In the preferred embodiment, a manager or a head can then be assigned to manage or oversee the defined task or the assigned task. In a preferred embodiment, every defined task or assigned task which is created will have a task manager or a task head assigned thereto. Any user or individual who sends, receives, or views, the first or initial message can determine that the defined task or the assigned task should be created.

It is important to note that, in the hierarchy of FIG. 2, the first or initial message is the starting point for any resulting stream created by and stored by the apparatus 100 of the present invention. It is also important to note that a stream for a task, a project, a project task, project talk, or a message, can also be created directly from, or as the result of, a message.

If a defined task or an assigned task is created, any user or individual who sends, receives, or views, the first or initial message, or who sends, receives, or views, any message creating the defined task or the assigned task, can decide whether a project or projects should be created in order to accomplish the defined task or the assigned task. If a project is to be created, then a manager or a head will be assigned to manage or oversee the project. In a preferred embodiment, each project created will have a project manager or a project head assigned thereto. Once a project is determined to be created, then such a project is created as shown in FIG. 2, and any or all information regarding the creation of the project, and/or information regarding the project, will be stored in the server 10, in a database associated with the server 10, and/or in an external database.

Thereafter, any user or individual, or the project manager or project head, who sends, receives, or views, the message creating the project can decide whether, and what, project tasks are to be created in order to accomplish the project. If a project is created, then a manager or a head will then be assigned to manage or oversee the project. If a project task is determined to be created, then such a project task is created as shown in FIG. 2, and any or all information regarding the creation of the project task, and/or any information regarding the project task will also be stored in the server 10, in a database associated with the server 10, and/or in an external database. Once a project task is to be created, then a project task manager or project task head will then be assigned to manage or oversee the project task.

Any and/or all information regarding any messages or replies thereto which result in the creation of the above referenced defined tasks or assigned tasks, projects, project tasks, messages, and/or project talk, will be stored in the server 10, in a database associated with the server 10, and/or in an external database.

At any time during any communications regarding any of the above defined tasks or assigned tasks, projects, project tasks, messages, and/or project talk, a new defined task or assigned task, a new project, a new project task, project talk, and/or a new message, can be created in response to any other message sent by any of the users or individuals involved in any communications or messages regarding the created defined task or assigned task, the project, the project task, the message, and/or the project talk.

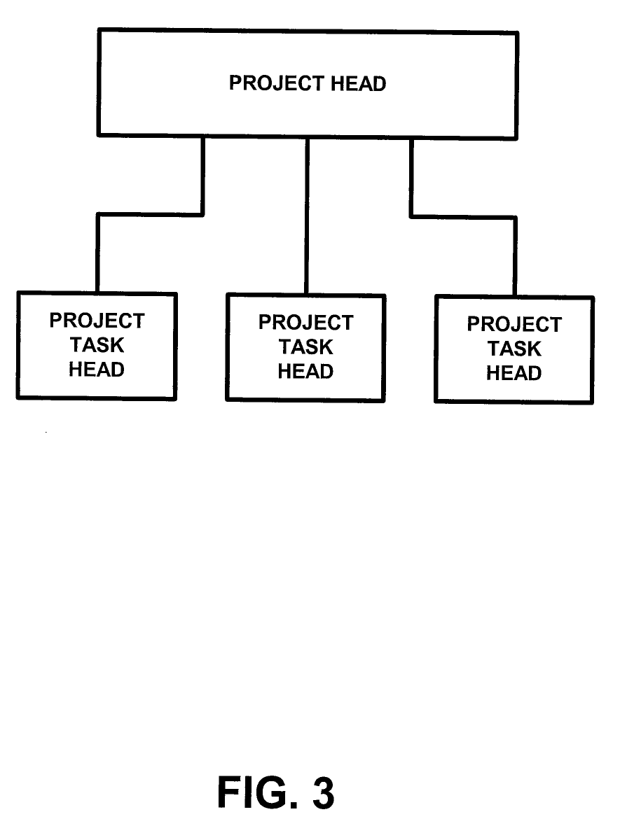

FIG. 3 illustrates a block diagram of a preferred embodiment hierarchy of a typical relationship between a project manager or project head and a project task head. With reference to FIG. 3, the Project Manager or Project Head oversees one or more Project Task Heads.

In a preferred embodiment of the present invention used, for example, in an enterprise organization, user or individual relationships to other users or individuals can be defined by either a manager-aid relationship, where one party is a manager of the other an aid, and a peer relationship in which the parties are only peers to one another. In a preferred embodiment, one of the criteria attributes defined when a user or individual is initially introduced into the system is the user relations criteria which defines the relationship between the user or individual vis-à-vis other users or individual (also referred to as “Associates”) whom that user or individual may be working with on a day-to-day basis.

In a preferred embodiment, relationships between users or individuals can be defined, re-defined, changed, created, or dissolved, at any time, and by any authorized person.

In a preferred embodiment, the above-described user relations can become that of a “direct associate” within a defined committee while all other associates of the enterprise can then be considered to be “non-direct associates”. For almost every user or individual, there can exist, or be assigned, at least one “manager” (supervisor) relationship. To the managing user or individual, an added user or individual can be considered to be an “aid” or an assistant or helper, and that aid can, in turn, serve as another user's or individual's manager.

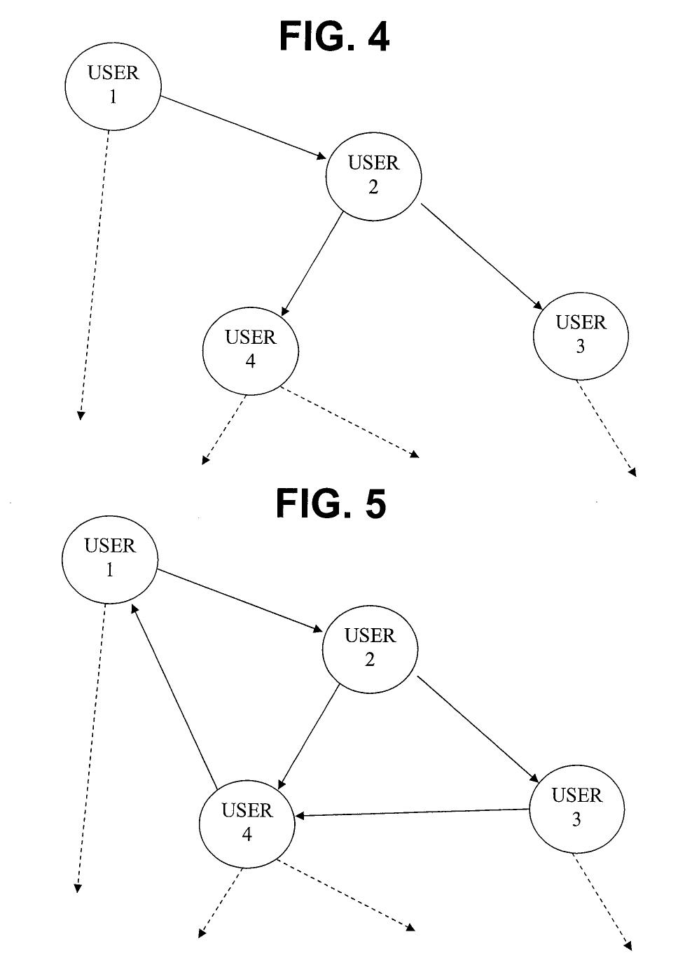

FIG. 4 illustrates a simple one-way relationship which may be defined from one user or individual to another as shown by arrows which depict a manager to aid relationship with the aid being on the receiving end of the respective arrowhead.

In a preferred embodiment, a manager-aid relationship can be used to determine or to define a user's or an individual's ability to assign a defined task(s) or an assigned task(s), a project(s), or a project task(s), to other users or individuals.

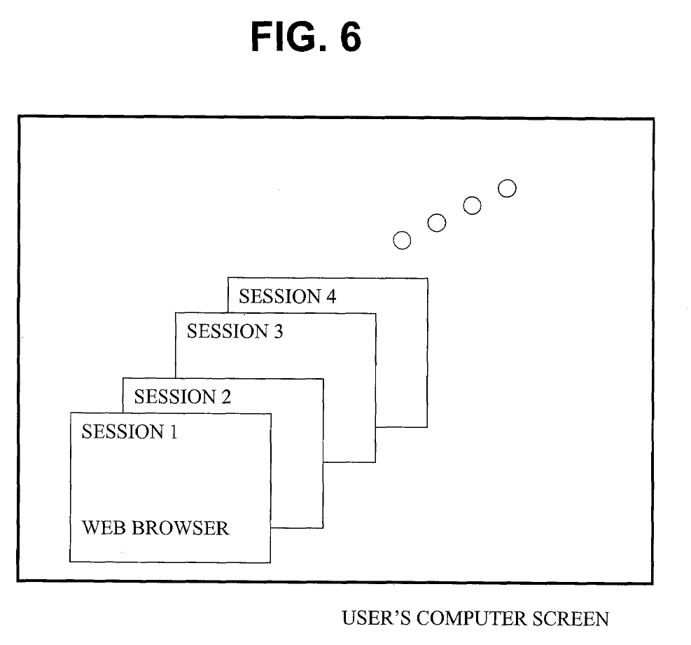

FIG. 5 illustrates a more complicated relationship between users or individuals which can also be established wherein an aid to one manager can also be a manager to the manager of his or her manager. It should be noted that a relationship between users or individuals can be reversed depending upon the committee, the defined task or assigned task, the project, or the project task.

In a preferred embodiment, all users or individuals may not or need not be on-line with the apparatus 100 at the same time in order to view a message(s) or a message record(s) which may be being viewed by other users or individuals. Rather, a user or individual can also access the server 10 at any time and retrieve a message(s) or a message record(s) at any time and from any location via any suitable user computer 20.

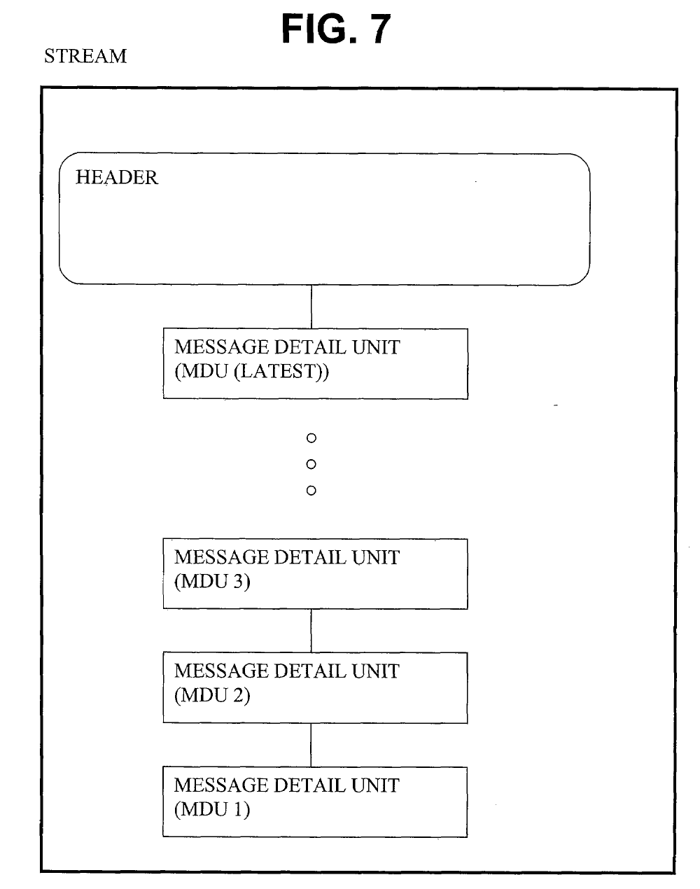

In a preferred embodiment, the user or individual can view a message or message record for any of message, defined task or assigned task, project, project task, and/or project talk described herein in a screen session or sessions via the user computer 20. In a preferred embodiment, the user or individual can also view any number of messages or message records for any number of the messages, defined tasks or assigned tasks, projects, project tasks, and/or project talk, described herein in multiple sessions via the user computer 20. FIG. 6 illustrates an example of a view of a display screen of a user computer 20 showing numerous sessions being open and available to the user or individual via the user computer 20.

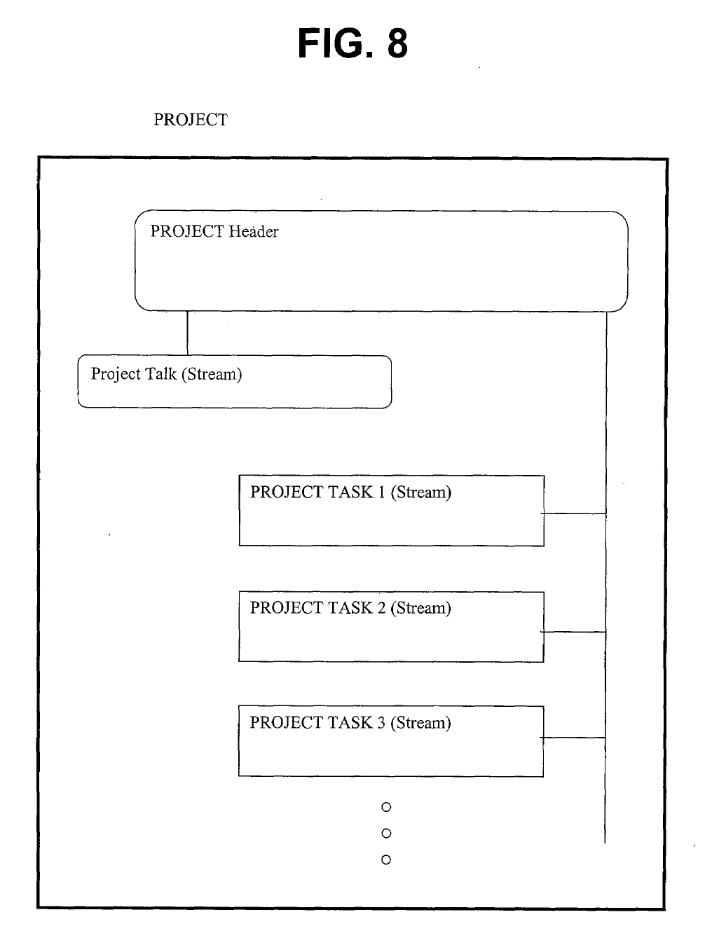

FIG. 7 illustrates a diagram of an example stream which is utilized in connection with the apparatus 100 and method of the present invention. With reference to FIG. 7, the stream consists of a header and a string or chain of connected message detail units (MDUs) associated with that header, in the order from the most recent message detail unit (MDU) to earliest message detail unit (MDU).

In a preferred embodiment, users or individuals involved with or authorized to receive one MDU may not necessarily be involved with or authorized to receive all MDUs within a given stream. Instead, a user or individual may only view a portion of the stream dealing with a particular task, project, or project task, for which he or she is involved. A task stream can be provided with information regarding a specific goal, a start date, a deadline, and a head assigned to accomplish the specific goal as shown in FIG. 7.

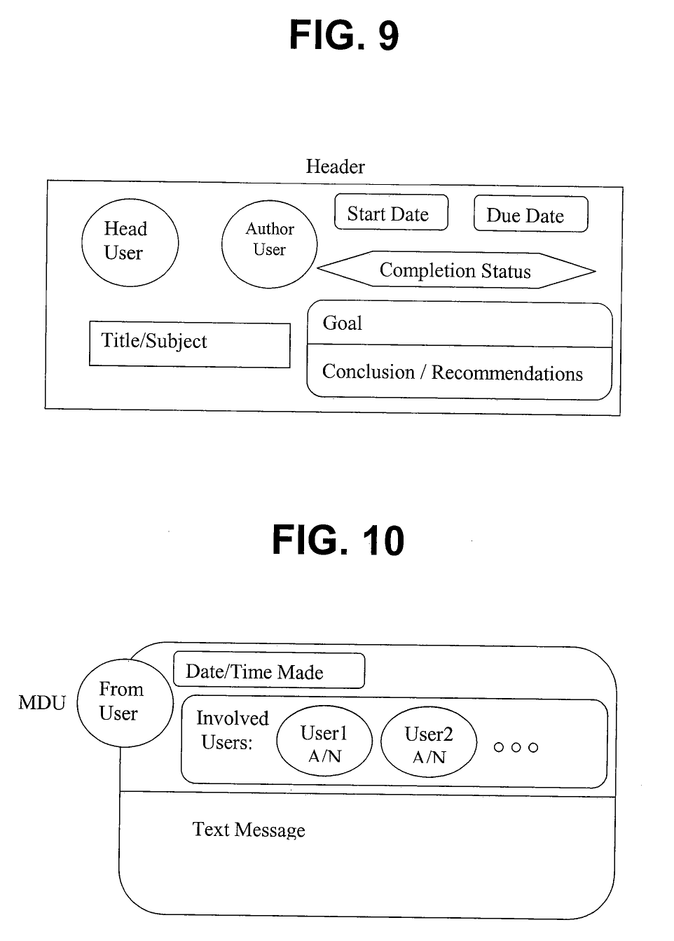

In a preferred embodiment, a task stream may exist by itself among other unrelated task streams or within a project which may be listed among other related project task streams as illustrated in FIG. 8. FIG. 8 illustrates an example diagram of a Project task Stream platform that can be used in completing a Project, showing a Project Header, Project Task Streams, and a Project Talk stream.

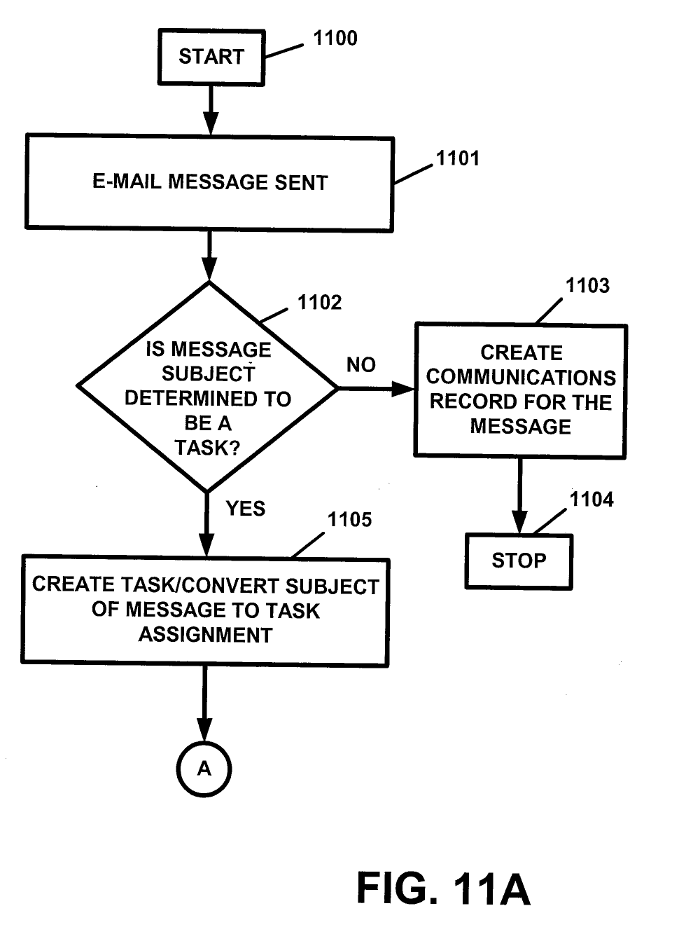

FIG. 9 illustrates a preferred embodiment example of a defined task header or an assigned task header or a project header utilized in the respective streams of FIGS. 7 and 8. With reference to FIG. 9, the header includes information regarding a Head User, an Author User, a Start Date, a Due Date, a Completion Status, a Title/Subject, a Goal, and/or a Conclusion/Recommendation. The header can also include any other information deemed appropriate or necessary.

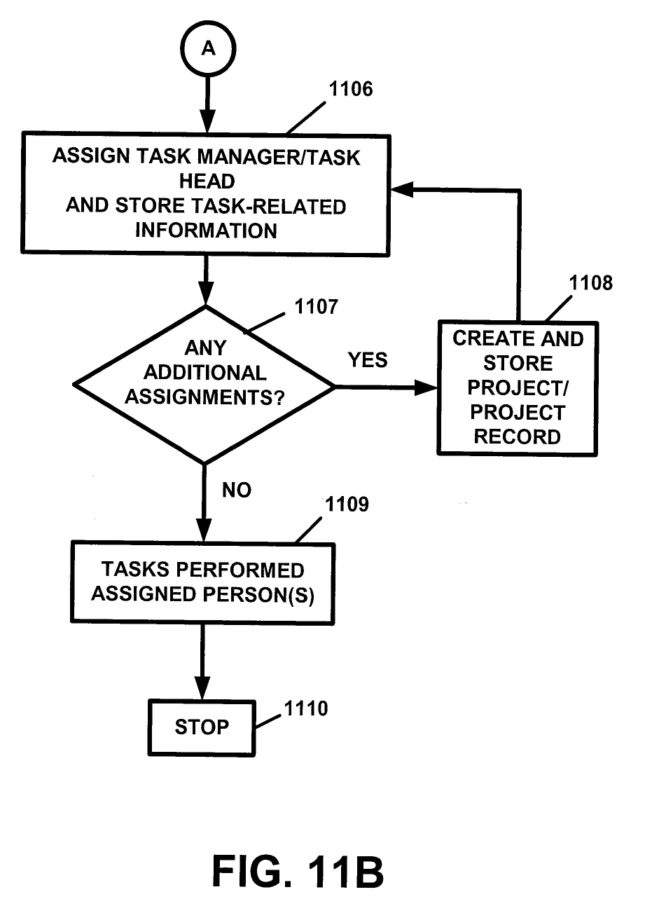

FIG. 10 illustrates a preferred embodiment example of a Message Detail Unit (MDU). In the embodiment of FIG. 10, the MDU contains information regarding the From User, the Date/Time Made, the Involved Users (User 1 A/N), (User 2 A/N), etc., and the Text Message, and/or can include any other information deemed appropriate or necessary. It is important to note, that the notation “A/N”, as used herein, refers to a user's acknowledgement or failure to acknowledge the MDU.

Any of the herein-described information contained in any of the respective headers can be selected in any appropriate manner by any authorized party, and information, such as, for example, start dates and due dates, can also be selected and/or defined relative to the start dates and/or due dates of other and/or related defined tasks or assigned tasks, projects, and/or project tasks.

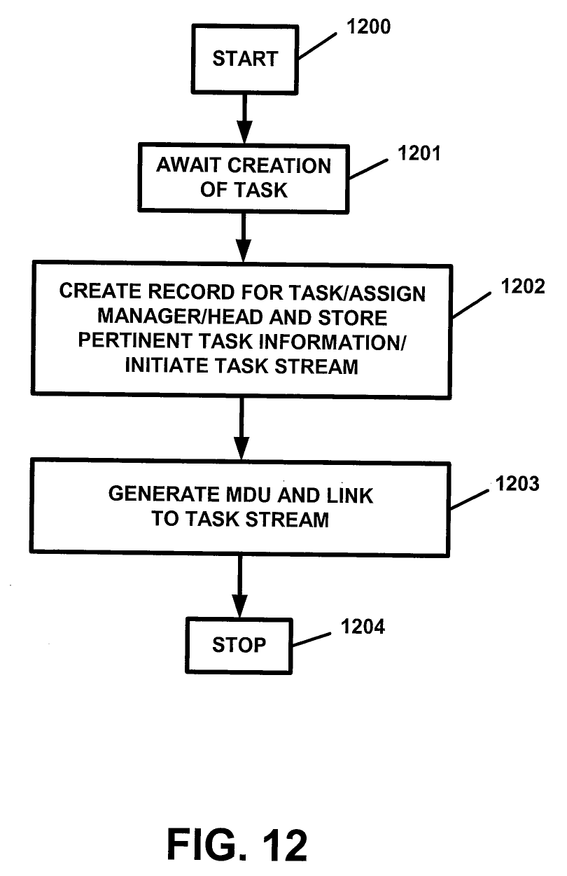

FIGS. 11A and 11B illustrate a preferred embodiment method for using the apparatus 100 of the present invention to create a defined task or an assigned task from a message. In a preferred embodiment of the present invention, a defined task or an assigned task can originate from any message from one user or individual to one or more other users or individuals.

With reference to FIGS. 11A and 11B, the operation of the apparatus 100 commences at step 1100. At step 1101, a user or individual (“the sending user or individual”) can generate and send an e-mail message to one or more other users or individuals (“the receiving user(s) or individual(s)”). The e-mail message can contain any subject matter. For example, the e-mail message can simply contain a greeting or message between friends. The e-mail message can also contain subject matter which may require or need attention, such as, for example, a recognized need to perform a task, such as in a business or enterprise setting.

At step 1101, any one or more of the sending user or individual or the receiving user(s) or individual(s) can determine whether or not to create a defined task or an assigned task to address the subject matter of, or in, the message. In this manner, subject matter of a message can, in a sense, be “converted” into a defined task or an assigned task (hereinafter, “the task”). The creation of the task can be performed in any appropriate manner, such as, for example, by selecting a “Create Task” box or button in or on the e-mail message or a header of the e-mail message. Information regarding the e-mail message, the subject matter of the e-mail message, the sender of the e-mail message, the receiver or receivers of the e-mail message, the text of the e-mail message, and information regarding whether a task is created, are stored in the respective server 10 in which the e-mail message is stored and from which it was retrieved or transmitted.

At step 1102, the server 10 will determine whether or not a task has been created or, to put it in other words, whether the subject matter of the e-mail message has been converted into a task. If, at step 1102, the server 10 determines that no task was created from the subject matter of the e-mail message, the operation of the apparatus 100 will proceed to step 1103 and the server 10 will create a communication record for the e-mail message and any response or responses thereto. The communication record containing the e-mail and any response or responses thereto will then be stored in the server 10, in a database of or associated with same, and/or in an external database. Thereafter, the operation of the apparatus 100 will cease at step 1104.

If at step 1102, it is determined that a task was created from the subject matter of the e-mail message, or that the subject matter of the e-mail message has been converted into a task, the operation of the apparatus 100 will proceed to step 1105 and the server 10 will create a communications record for the task and create and store any information regarding any task assignment associated with the task. At step 1105, the communication record containing the information regarding the task and the task assignment will then be stored in the server 10, in a database of or associated with same, and/or in an external database.

At step 1106, an authorized user or individual can provide and/or the server 10 can assign and store information regarding the task manager or task head for the task from information regarding the user or individual who has been assigned to the task, such as from information entered into or contained in any appropriate field in a reply e-mail message, or from information regarding the user or individual who is to be automatically assigned, such as from the user's or individual's assigned responsibilities in the organization. At step 1106, the information regarding the task manager or task head will be stored in the server 10, in a database of or associated with same, and/or in an external database. At step 1106, information regarding any and/or all users or individuals who are to be involved in performing the task, and the relationship(s) between these users or individuals (e.g. head, manager, aid, or peer) can also be stored in the communications record for the task in the server 10, in a database of or associated with same, and/or in an external database.

At step 1106, information regarding a goal of the task, a start date, a completion date, and/or a deadline, associated with the task can also be stored in the communication record for the task in the server 10, in a database of or associated with same, and/or in an external database.

At step 1107, the server 10 can determine from information obtained from the e-mail message, from any response(s) thereto, from any other information provided by any appropriate user(s) or individual(s), and/or from any previously defined rule or rules concerning task execution, whether or not any additional assignments are required to execute the task. If at step 1107, it is determined that an additional assignment, or multiple assignments, needs to be performed, then the operation of the apparatus 100 will proceed to step 1108 and a project record will be created and stored for a project which is identified to be created to address the additional assignment or each assignment of the multiple assignments.

Thereafter, the operation of the apparatus will proceed to step 1106 and the server 10 will, in response to information provided by a user or individual or information stored in the server 10, store information regarding the project manager or project head for the project from information regarding the user or individual who has been assigned to the project, such as from information entered into or contained in an appropriate field in a reply e-mail message, or from information regarding the user or individual who is to be automatically assigned, such as from the user's or individual's assigned responsibilities in the organization. At step 1106, the information regarding the project manager or project head will also be stored in the server 10, in a database of or associated with same, and/or in an external database.

At step 1106, information regarding any and/or all users or individuals who are to be involved in performing the project, and the relationship(s) between these users or individuals (e.g. head, manager, aid, or peer) can also be stored in the communications record for the project in the server 10, in a database of or associated with same, and/or in an external database. Thereafter, the operation of the apparatus 100 will proceed once again to step 1107 and the operation of the apparatus 100 will continue.

If, at step 1107, it is determined that no additional assignment needs to be performed, then the operation of the apparatus 100 will proceed to step 1109. At step 1109, the user(s) or individual(s) assigned to the task will perform his/her/their respective assignment(s) to execute and complete the task. Any e-mail messages, and any message detail units (MDUs), transmitted by or received by the user(s) or individual(s) assigned to the task, can be organized together in streams and can be stored in the communications record associated with the task in the server 10, in a database of or associated with same, and/or in an external database. Thereafter, the operation of the apparatus 100 will cease at step 1110.

At any time throughout the above-described process, any authorized user or individual, who has been assigned to the task or otherwise, can access and retrieve any messages or streams associated with the task.

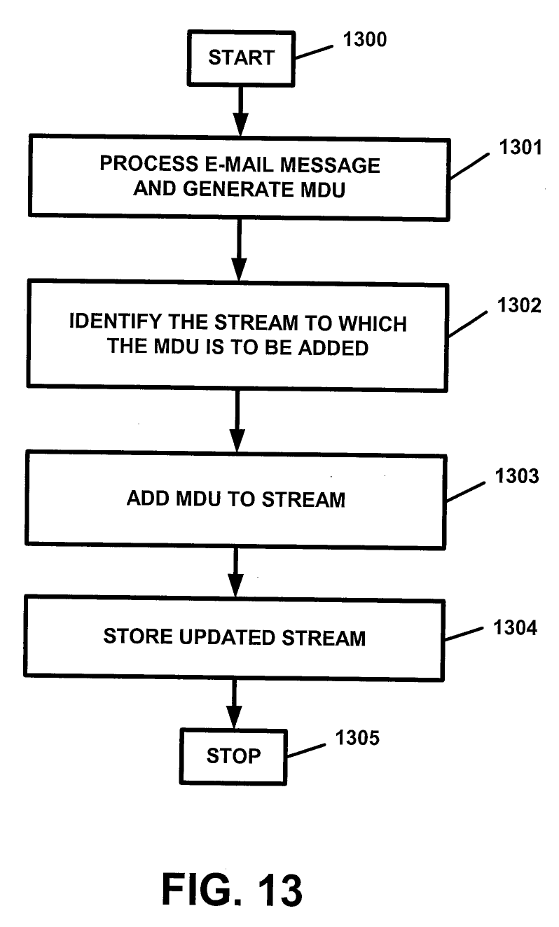

FIG. 12 illustrates a preferred embodiment method of utilizing the apparatus 100 of the present invention in order to create or establish a tasking platform for a task, which, in a preferred embodiment, can include the creation of, and the development and/or propagation of, a stream for the task (“task stream”). With reference to FIG. 12, the operation of the apparatus 100 commences at step 1200. At step 1201, the apparatus 100 will await the creation of a task.

Upon the creation of the task, the operation of the apparatus 100 will proceed to step 1202 and a communication record for the task will be created with information regarding same, including, but not limited to, the information regarding the task manager or task head, information regarding any and/or all users or individuals who are to be involved in performing the task, and the relationship(s) between these users or individuals (e.g. head, manager, aid, or peer, etc.), and/or information regarding a goal of the task, a start date, a completion date, and/or a deadline, associated with the task, can also be stored in the communication record for the task in the server 10, in a database of or associated with same, and/or in an external database.

At step 1202, any message or messages associated with the task, such as the message from which the task was created or the subject matter of which was converted into the task, and any response or responses to same, can also be stored in the communication record for the task in the server 10, in a database of or associated with same, and/or in an external database. At step 1202, the server 10 will also create or initiate the stream for the task (“task stream”).

At step 1203, as e-mail messages are generated and transmitted to, from, or between, any of the users or individuals assigned to the task, and/or as well as any other users or individuals, the server 10 will, for each e-mail message, generate a message detail unit (MDU) corresponding to the e-mail message and link the MDU to the stream for the task. The operation at step 1203 will continue with an MDU or multiple MDUs being added to the stream for the task until the task is completed or until the cessation of any e-mail messages associated with the task. Each time the stream for a task is updated to include a new MDU the updated stream will be stored in the server 10, in a database of or associated with same, and/or in an external database.

Upon completion of the task, or upon the cessation of e-mail messages associated with the task, the operation of the apparatus 100 will cease at step 1204.

It is important to note that any and/or all streams created by the apparatus 100 of the present invention, including streams for any and all defined tasks or assigned tasks, any projects, any project tasks, any project talk, and/or any messages, described herein, can be created, updated, and stored, in the manner described herein with reference to the method described in FIG. 12.

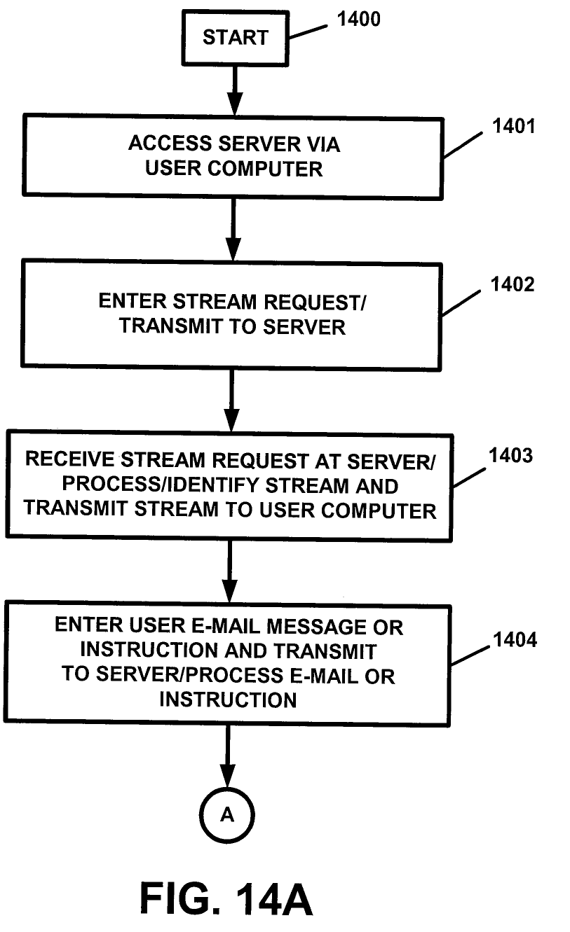

FIG. 13 illustrates a preferred embodiment method for utilizing the apparatus 100 of the present invention to update a stream for any of the defined tasks or assigned tasks, projects, project tasks, project talk, and/or messages, described herein. The method of FIG. 13 describes a preferred embodiment method for performing the stream updating which is described hereinabove as being performed at step 1203 of the preferred embodiment of FIG. 12.

With reference to FIG. 13, the operation of the apparatus 100 commences at step 1300. At step 1301, upon receiving an e-mail message which is sent from a sending user or individual, and before transmitting the e-mail message to a receiving user(s) or individual(s), the server 10 will process information regarding the e-mail message and will generate an MDU associated with the e-mail message. At step 1302, the server 10 will identify the stream, for the respective defined task or assigned task, project, project task, project talk, or message, which is to be updated so as to include the newly generated MDU.

At step 1303, the server 10 will update the identified stream by adding the newly generated MDU to same. Thereafter, at step 1304, the updated stream will be stored in the server 10, in a database of or associated with same, and/or in an external database. At step 1304, the updated stream is available for accessing and viewing by any authorized user or individual.

At step 1304, the server 10 can also, in a preferred embodiment, record information regarding whether or not any one or more users or individuals have acknowledged receiving the new MDU in the stream. Thereafter, the operation of the apparatus 100 will cease at step 1305.

It is important to note that the above method can be utilized to process e-mail messages, generate an MDU, and update the appropriate stream, for any streams for any of the herein-described defined tasks or assigned tasks, projects, project tasks, project talk, and/or messages.

The apparatus 100 and method of the present invention provides an efficient and effective means by which to communicate, access, organize, and/or manage, information in a network environment. Any user or individual involved in an enterprise, organization, group, association, and/or any other relationship with others can utilize the apparatus 100 of the present invention to communicate with others, access pertinent information in an organized and efficient manner, organize their communications, and/or manage their communications and/or interaction with other users or individuals.

Streams, which can be task-based, project-based, project task-based, project-talk-based, or message-based, can be easily accessed, viewed, responded to, and/or otherwise addressed, in a simple an easy manner. The ease and simplicity provided by the apparatus 100 and method of the present invention facilitates improved and more organized communication efficiencies and effectiveness, while promoting a more organized dissemination of information and fostering greater accountability among users and individuals who use the present invention.

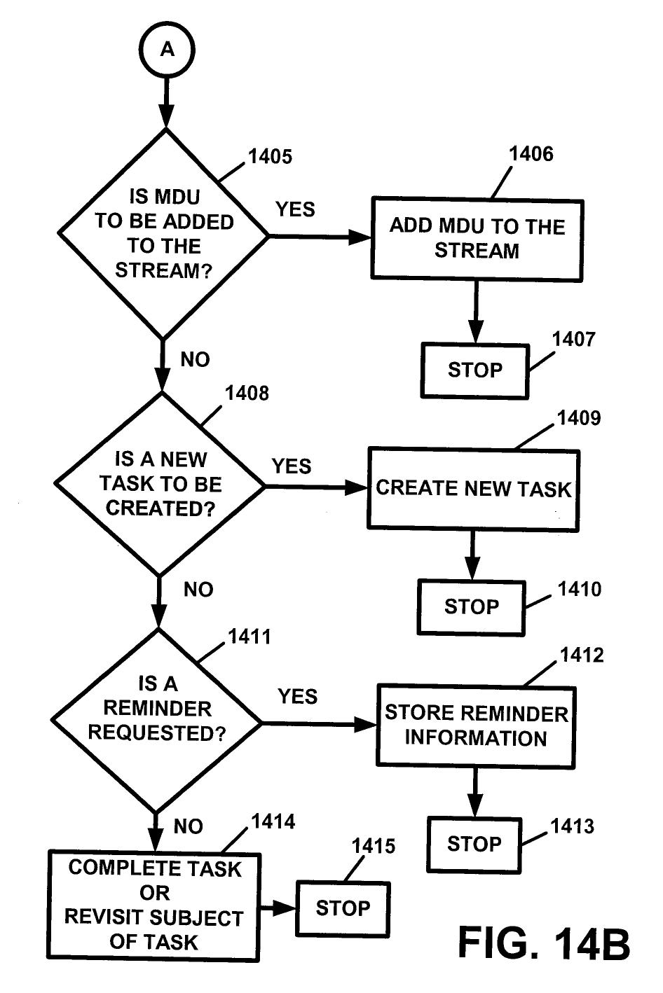

FIG. 14 illustrates a preferred embodiment method for utilizing the apparatus 100 and method of the present invention to access and act upon messages and information contained therein. With reference to FIG. 14, the operation of the apparatus 100 commences at step 1400. At step 1401, a user or individual can access the server 10 via a user computer 20. In a preferred embodiment, the user or individual may be required to provide a password or some other form of identification to gain authorized access to the information stored at the server 10. Once obtaining access to the server 10, the user or individual can, at step 1402, request a particular stream (“the stream request”) for any defined task or assigned task (“task”), any project, any project task, any project talk, and/or any message, which he or she is interested in accessing.

At step 1402, the stream request is transmitted from the user computer 20 to the server 10. At step 1403, the server 10 will receive and process the stream request, identify the requested stream for the identified task, project, or project task, project talk, and/or message, and transmit the requested stream to the user computer 20.

At step 1404, the user or individual can view the stream and decide whether or not he or she desires to add a message in the form of a new MDU to the stream. If the user or individual desires to add to, or to update, the stream, such as by responding to a message or by communicating a new message, the user or individual will generate a new e-mail message to a recipient or recipients and transmit the new e-mail message to the server 10 for processing in a manner consistent with the present invention.

At step 1404, instead of, or in addition to, adding a new MDU to the stream, the user or individual can decide to create a new task from the stream and/or to add a reminder request regarding the task which is the subject of the stream, and/or the user or individual can simply decide to complete the task which is the subject of the stream.

If, at step 1404, the user or individual decided to add a new MDU to the stream, then the new e-mail message can be generated by the user or individual and can be transmitted to the server 10. Similarly any instruction to create a new task from the stream, or to add a reminder request regarding the task which is the subject of the stream, can be transmitted to the server 10 at step 1404.

At step 1404, the server 10 will either receive the new e-mail message or determine that the user or individual has exited the stream without adding a new e-mail message. If a new e-mail message is received, then the server 10 will recognize the receipt of the new e-mail message to mean that the user or individual desired to add a new MDU to the stream.

At step 1405, the server 10 will determine, based on the user or individual response, whether a new MDU is to be added to the stream. If, at step 1405, it is determined that a new MDU is to be added to the stream, the operation of the server 10 will proceed to step 1406. At step 1406, the server 10 will generate the appropriate MDU in response to the new e-mail message, add the MDU to the stream so as to update the stream, and store the updated stream. The updated stream can be stored in the server 10, in a database of or associated with same, and/or in an external database. Thereafter, the operation of the apparatus 100 will cease at step 1407.

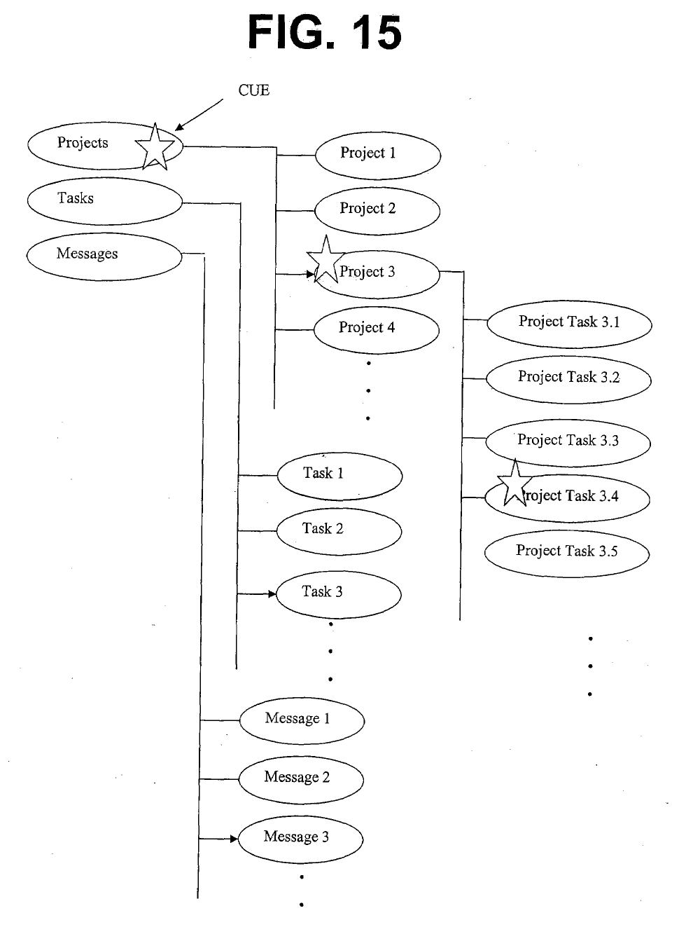

In another preferred embodiment, the user or individual, upon accessing the server, can be provided with a screen showing tasks, projects, project tasks, and/or messages, which need to be viewed and/or responded to by the user or individual. FIG. 15 illustrates an example screen shot of the display screen of the user computer 20 displaying to the user or individual the respective tasks, project(s), project task(s), and/or message(s), in or with which the user or individual is associated and/or otherwise deemed to be included. Any task, project, project task, and/or message, pertaining to the user or individual which may be available for viewing by the user or individual or which may be deemed important or required for the user or individual to view can be denoted by a cue, flag, or other indication, such as, for example, the star shown in FIG. 15. Thereafter, the user or individual can elect to access and view the pertinent message or messages.

With reference once again to FIG. 14, if at step 1405, the server 10 determines that the user or individual did not desire to add a new MDU to the stream, the operation of the apparatus 100 will proceed to step 1408. At step 1408, the server 10 will determine whether the user or individual has instructed the server 10 to create a new task from the stream. If at step 1408, the server 10 determines that the user or individual has instructed that a new task be created from the stream, then the operation of the apparatus 100 will proceed to step 1409 and a new task will be created in a manner described herein with reference to FIGS. 11A and 11B. Thereafter, the operation of the apparatus 100 will cease at step 1410.

If, at step 1408, the server 10 determines that a new task is not to be created, then the operation of the apparatus 100 will proceed to step 1411, and the server 10 will determine whether or not a reminder was requested regarding the task which is the subject of the stream. If at step 1411, it is determined that a reminder has been requested, the operation of the apparatus 100 will proceed to step 1412 and information regarding the reminder will be stored in the server 10, in a database of or associated with same, and/or in an external database, and the reminder will be provided in accordance with the user's or individual's instructions. Thereafter, the operation of the apparatus 100 will cease at step 1413.

If at step 1411, it is determined that a reminder has not been requested, the operation of the apparatus 100 will proceed to step 1414 and the task will either be completed by the user or individual, or, if not completed, the subject of the task can be revisited with a new message or a new MDU being subsequently added to the stream for the task. Thereafter, the operation of the apparatus 100 will cease at step 1415.

In another preferred embodiment, the apparatus 100 and method of the present invention can be used, in a manner similar to and/or analogous to the preferred embodiments described herein, in connection with instant messaging messages and instant messaging systems.

In any and/or all of the embodiments described herein, an e-mail message which originates from outside an enterprise, company, group, or association, can be sent to the “in-box” of a user or individual. The user or individual can, at any time, access and/or view the externally originated e-mail message. The user or individual can also, at any time, incorporate the externally originated e-mail message into an existing stream as a new MDU. The user or individual can also create a new defined task or assigned task, a new project, a new project task, new project talk, or a new message, in response to the externally originated e-mail message. The user or individual can also send a copy of any type of e-mail message described herein into two or more streams.

In any and/or all of the embodiments described herein, the apparatus 100 can also be utilized in order to take notes or minutes of or during a meeting between users or individuals and for creating an assigned task directly from these notes or minutes. In this manner, the apparatus 100 can be used to create defined tasks or assigned tasks from meeting notes or minutes. These defined tasks or assigned tasks can be stand alone tasks or project tasks of a new or existing project.

In any and/or all of the embodiments described herein, the apparatus 100 can also be utilized in order to provide a user or individual with the ability to access recently visited streams.

In any and/or all of the embodiments described herein, a user or individual can also access any and/or all of the streams of, or associated with, any and/or all of the defined tasks or assigned tasks, projects, project tasks, project talk, and/or messages, which he or she is or may be responsible for or in which he or she is or may be involved. The user or individual can also access any and/or all of the streams of, or associated with, any and/or all of the defined tasks or assigned tasks, projects, project tasks, project talk, and/or messages, in which any aid of the user or individual is or may be responsible for or is or may be involved.

In any and/or all of the embodiments described herein, the apparatus 100 can also be utilized in order to allow an authorized user or individual to, at any time, access any and/or all of the streams of, or associated with, any and/or all of the defined tasks or assigned tasks, projects, project tasks, project talk, and/or messages, which are in existence in his or her enterprise, company, group, or association, for which the user or individual is authorized.

In any and/or all of the embodiments described herein, any user or individual described herein can be assigned any number of e-mail addresses with which he or she can utilize the apparatus 100 and method of the present invention.

In still another embodiment, any user or individual, can request, and/or can be provided with, periodic reminder messages for any of the defined tasks or assigned tasks, projects, project tasks, project talk, and/or messages, or streams for same, described herein. In a preferred embodiment, a user or individual can create reminder message for himself or herself as well as a reminder message for any other user(s) or individual(s). In any and/or all of the embodiments described herein, a reminder message can be set up to generate an MDU or MDUs which can be inserted into or otherwise added to any of the herein-described streams.

In any and/or all of the embodiments described herein, the apparatus 100 and method of the present invention can also be utilized in conjunction with security features which dispense with the need for a network administrator. With regard to messages, tasks, projects, project tasks, and/or project talk, users or individuals may need to have access to other common sharable information. The apparatus 100 and method of the present invention can be utilized in conjunction with security features which can include utilizing authorized access levels and/or privileges to allow a user or individual to have access to, to read, to read only, to read and/or modify, and/or to otherwise act in any appropriate manner, regarding any shared information of any kind or type which is utilized in connection with the apparatus 100 and method of the present invention, along with the ability for a user or individual, who has a certain authorized access level, or certain privileges, to be able to control the access levels and/or privileges of others in the enterprise, company, group, or association.

In a preferred embodiment, a user or individual having a certain authorization level and/or privileges can also pass along and/or define an authorization level, or a lower level of authorization, or can pass along and/or define his or her privilege rights, or lesser privilege rights, to another user or individual.

In a preferred embodiment, authorization levels and privileges can also include the ability of a user or individual to, in turn, pass along these authorization levels, or a lower authorization level(s), and/or privilege rights, or lesser privilege rights, to another user or individual, with authorization levels and privileges being defined or assigned throughout a communication infrastructure or platform in the enterprise, company, group, or association. In this manner, the need for a centralized network administrator can be dispensed with.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. A computer-implemented method, comprising:
transmitting a message to a user computer;
receiving a reply to the message, wherein the reply contains information for creating a task, a project, a project task, or a message stream, in response to subject matter contained in the message;
determining, using a processing device or a computer, whether the reply to the message contains a request to create a task, a project, or a project task, in response to the subject matter contained in the message;
creating a communication record for the message and the reply to the message if the reply to the message does not contain a request to create a task, a project, or a project task, in response to the subject matter contained in the message, or creating a communication record for a task, a project, or a project task, if the reply to the message contains a request to create a task, a project, or a project task; and
storing the communication record in a database or a memory device.

2. The computer-implemented method of claim 1, wherein the communication record contains information regarding a task created in response to the subject matter of the message.

3. The computer-implemented method of claim 1, wherein the communication record contains information regarding a project created in response to the subject matter of the message.

4. The computer-implemented method of claim 1, wherein the communication record contains information regarding a project task created in response to the subject matter of the message.

5. The computer-implemented method of claim 1, wherein the communication record contains information regarding a message stream created in response to the subject matter of the message.

6. The computer-implemented method of claim 1, further comprising:
storing information regarding a task created in response to the subject matter of the message, wherein the information regarding a task includes information regarding a goal of the task, a start date for the task, a completion date for the task, a deadline for the task, a manager for the task, or a task head.

7. The computer-implemented method of claim 1, further comprising:
storing information regarding a project created in response to the subject matter of the message, wherein the information regarding a project includes information regarding a goal of the project, a start date for the project, a completion date for the project, a deadline for the project, a manager for the project, or a project head.

8. The computer-implemented method of claim 1, further comprising:
storing information regarding a project task created in response to the subject matter of the message, wherein the information regarding a project task includes information regarding a goal of the project task, a start date for the project task, a completion date for the project task, a deadline for the project task, and an individual responsible for performing the project task.

9. The computer-implemented method of claim 1, wherein a task is created in response to the subject matter of the message, and further wherein the computer-implemented method further comprises:
creating a communication record for a project associated with the task; and
storing the communication record for the project.

10. The computer-implemented method of claim 1, wherein a project is created in response to the subject matter of the message, and further wherein the computer-implemented method further comprises:
creating a communication record for a project task associated with the project; and
storing the communication record for the project task.

11. The computer-implemented method of claim 1, further comprising:
creating a stream containing at least one second message or at least one message unit associated with or relating to the task, the project, the project task, or the message.

12. The computer-implemented method of claim 11, further comprising:
updating the stream to create an updated stream by adding at least one second message or at least one message unit to the stream.

13. The computer-implemented method of claim 11, wherein the at least one message unit is derived from the at least one second message.

14. The computer-implemented method of claim 11, further comprising:
identifying the stream for which the at least one second message or the at least one message unit is associated.

15. The computer-implemented method of claim 11, further comprising:
linking or inserting the at least one second message or the at least one message unit with or into the stream.

16. The computer-implemented method of claim 12, further comprising:
storing the updated stream in the communication record for the task, the project, the project task, or the message.

17. The computer-implemented method of claim 1, further comprising:
storing information regarding a person responsible for or accountable for the task, the project, or the project task.

18. The computer-implemented method of claim 1, further comprising:
storing information regarding a privilege or a level of access assigned to an individual authorized to access shareable information, or storing information regarding a privilege or a level of access assigned to an individual authorized to access shareable information and storing information and a privilege level for allowing another individual to have a same or a lesser level of access to the shareable information.

19. A computer-implemented method, comprising:
receiving a request to access a stream of information associated with or related to a task, a project, a project task, or a message, wherein the request is transmitted from a user device;
processing the request with a processing device or a computer;
identifying the stream which is the subject of the request;
providing or transmitting the stream to the user device;
receiving an instruction or response transmitted from the user device in response to the stream, wherein the instruction or response contains a new message or a message unit to be added to the stream, a request to create a new task, or a request to be provided with a reminder regarding information contained in the stream;
processing the information contained in the instruction or response; and
adding the new message or the message unit to the stream, creating a communication record for a new task in response to the request to create a new task, or storing information for providing the reminder regarding information contained in the stream.

20. The computer-implemented method of claim 19, further comprising:
transmitting a reminder message to the user device in response to the request to be provided with a reminder.

21. A apparatus, comprising:
a transmitter, wherein the transmitter transmits a message to a user computer;
a receiver, wherein the receiver receives a reply to the message, wherein the reply contains information for creating a task, a project, a project task, or a message stream, in response to subject matter contained in the message;
a processing device or a computer, wherein the processing device or a computer determines whether the reply to the message contains a request to create a task, a project, or a project task, in response to the subject matter contained in the message, and further wherein the processing device or a computer creates a communication record for the message and the reply to the message if the reply to the message does not contain a request to create a task, a project, or a project task, in response to the subject matter contained in the message, or creates a communication record for a task, a project, or a project task, if the reply to the message contains a request to create a task, a project, or a project task; and
a database or a memory device, wherein the communication record is stored in the database or the memory device.
